(19) United States
(12) Patent Application Publication
(10) Pub. No.: US 2024/0025474 A1
(43) Pub. Date: Jan. 25, 2024

(54) STEERING SYSTEM

(71) Applicant: TOYOTA JIDOSHA KABUSHIKI KAISHA, Toyota-shi (JP)

(72) Inventor: Tomohiko TAKEDA, Nisshin-shi (JP)

(73) Assignee: TOYOTA JIDOSHA KABUSHIKI KAISHA, Toyota-shi (JP)

(21) Appl. No.: 18/325,248

(22) Filed: May 30, 2023

(30) Foreign Application Priority Data
Jul. 22, 2022 (JP) 2022-116937

(51) Int. Cl. B62D 5/04; B62D 15/02; B60C 23/02; B60W 40/107

(52) U.S. Cl. CPC B62D 5/0493; B62D 15/021; B60C 23/02; B60W 40/107

(57) ABSTRACT

A steering system includes a controller configured to execute: an input determination process to determine whether an external force is input to a vehicle based on longitudinal acceleration; a position identification process to identify an input tire that is one of a plurality of tires to which the external force is input based on air pressures of the tires when the external force is determined to be input to the vehicle; a load calculation process to (a) calculate deceleration of the vehicle or obtain information on the deceleration and (b) calculate a load received by the input tire due to the external force based on a difference between the longitudinal acceleration and the deceleration when the input tire is the tire of a steerable wheel; and an abnormality determination process to determine presence or absence of an abnormality of a steering rod based on the load and a steering angle.

### REFERENCE TO RELATED APPLICATIONS

This application claims priority from Japanese Patent Application No. 2022-116937 filed on Jul. 22, 2022. The entire content of the priority application is incorporated herein by reference.

### BACKGROUND ART

The following disclosure relates to a steering system.

A rack and pinion steering device includes a rack bar and a pinion shaft. A rack gear of the rack bar and a pinion gear of the pinion shaft are in engagement with each other. When the rack bar moves, tie rods move to thereby steer steerable wheels. The rack bar is one example of a steering rod. For instance, Japanese Patent Application Publication No. 2019-104488 discloses a steering system configured to detect an abnormality of a transmission device that transmits an output of an electric motor to the steering rod.

### SUMMARY

There has not been established a technique of detecting an abnormality of the steering rod such as the rack bar due to application of a load in a bending direction to the steering rod. The bending direction is a direction orthogonal to the axial direction of the steering rod. The application of the load in the bending direction to the steering rod may cause an occurrence of an abnormality of the steering rod such as bending. The abnormality of the rack bar caused by the load in the bending direction includes, for instance, deformation and breakage of a rack gear portion of the rack bar, poor engagement of the rack bar and the pinion shaft, etc. Such abnormality may cause the rack and pinion mechanism to be locked or to be free.

In a system in which the steering wheel and the rack bar are mechanically coupled to each other, a driver may sensuously notice the abnormality of the rack bar through the operation of the steering wheel. There is however a possibility even in such a system that the driver does not notice the abnormality of the rack bar (including a condition in which the rack bar is about to be abnormal). In a steer-by-wire system in which the steering wheel and the rack bar are not mechanically coupled, in particular, it is highly probable that the driver does not notice the abnormality of the rack bar through the operation of the steering wheel because of the configuration of the system.

Accordingly, an aspect of the present disclosure relates to a steering system capable of detecting an abnormality of the steering rod due to the load in the bending direction.

In one aspect of the present disclosure, a steering system includes: a steering actuator including a steering rod, a steering motor configured to apply a drive force to the steering rod, and a conversion mechanism configured to convert rotation of the steering motor to an axial movement of the steering rod, the steering actuator being configured to steer a steerable wheel; a steering angle sensor configured to detect a steering angle of the steerable wheel; an acceleration sensor configured to detect longitudinal acceleration that is acceleration of a vehicle in a front-rear direction; an air pressure sensor configured to detect an air pressure of each of a plurality of tires; and a controller including at least one processor and configured to obtain information on the steering angle, information on the longitudinal acceleration, and information on the air pressures of the plurality of tires. The controller is configured to execute: an input determination process in which the controller determines presence or absence of an input of an external force to the vehicle based on the longitudinal acceleration; a position identification process in which, when the controller determines that the external force is input to the vehicle, the controller identifies an input tire that is one of the plurality of tires to which the external force is input, based on the air pressures of the plurality of tires; a load calculation process in which, when the input tire is the tire of the steerable wheel, the controller (a) calculates deceleration of the vehicle or obtains information on the deceleration and (b) calculates a load received by the input tire due to the input of the external force based on a difference between the longitudinal acceleration and the deceleration; and an abnormality determination process in which the controller determines presence or absence of an abnormality of the steering rod based on the load and the steering angle.

According to the present disclosure, when the vehicle mounts a curb or the like and the external force is input to any one of tires, the input tire is identified and the load applied to the input tire is calculated. The load in the bending direction applied to the steering rod is influenced by a load in the front-rear direction and the steering angle. The greater the load in the front-rear direction, the greater the load in the bending direction applied to the steering rod. The greater a projection allowance of the steering rod with respect to the input tire, the greater a moment length, resulting in an increase of the load in the bending direction applied to the steering rod. The projection allowance of the steering rod corresponds to the steering angle. The controller determines the presence or absence of the abnormality of the steering rod based on the load and the steering angle. The configuration according to the present disclosure enables detection of the abnormality of the steering rod due to the load in the bending direction.

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a view illustrating a configuration of a steering system according to one embodiment of the present disclosure;

FIG. 2 is a view illustrating a configuration of a rack and pinion mechanism according to the embodiment;

FIG. 3 is a conceptual view for explaining a direction of a load applied to a rack bar in the present embodiment;

FIG. 4 is a conceptual view for explaining the direction of the load applied to the rack bar in the embodiment;

FIG. 5 is a flowchart for explaining a process of an abnormality detection control in the embodiment;

FIG. 6 is a flowchart for explaining in detail the process of the abnormality detection control in the embodiment;

FIG. 7 is a conceptual view of an abnormality determination map in the embodiment.

FIG. 8 is a flowchart for explaining in detail the process of the abnormality detection control in the embodiment;

FIG. 9 is a conceptual view of another abnormality determination map;

FIG. 10 is a view of the steering system of the embodiment illustrated in a different view point; and

FIG. 11 is a conceptual view of still another abnormality determination map.

### DETAILED DESCRIPTION

Referring to the drawings, there will be described below in detail a steering system 1 according to one embodiment of the present disclosure. It is to be understood that the present disclosure is not limited to the details of the following embodiment but may be changed and modified based on the knowledge of those skilled in the art. Each of the drawings is a conceptual view.

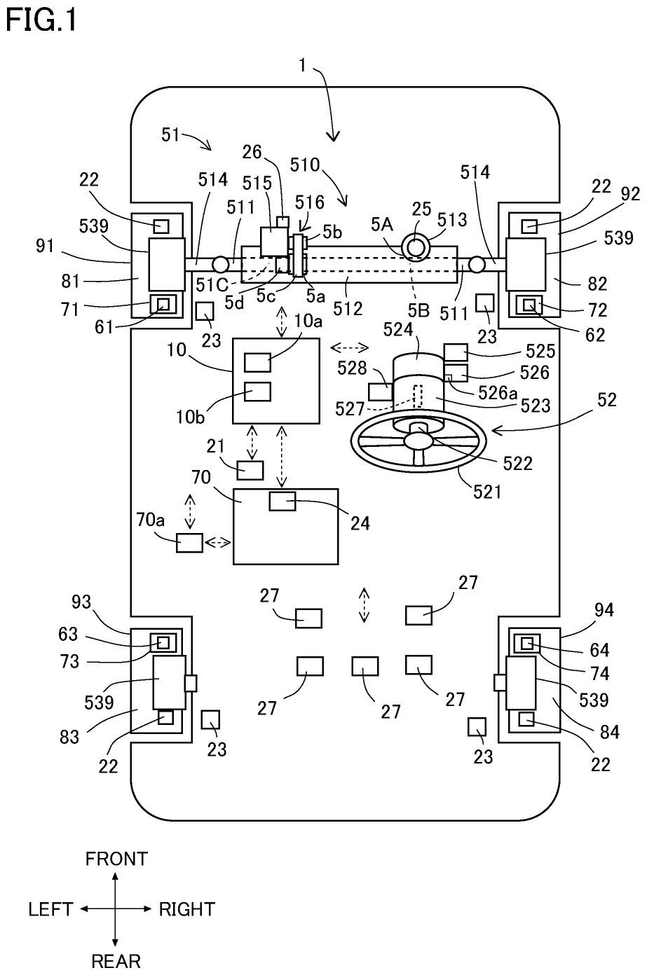

As illustrated in FIG. 1, the steering system 1 according to the present embodiment includes a controller 10, a steering device 51, and an operation device 52. The controller 10 is an electronic control unit (ECU) or a computer including at least one processor 10a and at least one memory 10b. The controller 10 is communicably connected to various sensors. For instance, the controller 10 is communicably connected to an acceleration sensor 21, a plurality of air pressure sensors 22, a plurality of vehicle height sensors 23, a pressure sensor 24, and a steering angle sensor 25, which are installed on a vehicle. Communication in the vehicle is performed through a CAN (car area network or controllable area network).

The acceleration sensor 21 detects longitudinal acceleration that is acceleration of the vehicle in the front-rear direction. The acceleration sensor 21 transmits its detection result to the controller 10. Each of the air pressure sensors 22 detects an air pressure of a corresponding one of a plurality of tires 81, 82, 83, 84 of the vehicle. Each air pressure sensor 22 transmits its detection result to the controller 10.

Each of the vehicle height sensors 23 detects a physical quantity relating to a height of the vehicle. Specifically, the vehicle height sensor 23 detects an amount of change in the vehicle height, in other words, the vehicle height sensor 23 detects a vehicle height stroke. The controller 10 can distinguish the direction of the change in the vehicle height, namely, the controller 10 can determine whether the change in the vehicle height is an upward change or a downward change, based on the detection results of the vehicle height sensors 23, e.g., the sign (plus or minus) of the current detected by each of the vehicle height sensors 23.

Each vehicle height sensor 23 includes, for instance, a lever mechanism and a variable resistor (both of which are not illustrated). The vehicle height sensor 23 detects the vehicle height stroke based on the movement of the lever mechanism. In the present embodiment, each of the vehicle height sensors 23 is provided for a corresponding one of the wheels 91-94 to detect a change in the distance between the corresponding suspension arm and the vehicle body. The vehicle height sensor 23 may have any other known configuration. The vehicle height sensor 23 may be provided for only each of the steerable wheels 91, 92. The vehicle height sensor 23 may be a sensor for detecting the vehicle height.

The pressure sensor 24 detects hydraulic pressures corresponding to hydraulic pressures of wheel cylinders 61, 62, 63, 64 of respective brake devices 71, 72, 73, 74, which are respectively provided for a plurality of wheels 91, 92, 93, 94 of the vehicle. While not illustrated, each of the brake devices 71-74 includes, for instance, a brake rotor, brake pads, and a piston configured to press the brake pads against the brake rotor in accordance with the hydraulic pressure of a corresponding one of the wheel cylinders 61-64. Based on the hydraulic pressures of the wheel cylinders 61-64, braking forces to be applied to the corresponding wheels 91-94 are determined.

The wheel cylinders 61-64 of the brake devices 71-74 are connected to a hydraulic pressure adjusting device 70 (whose fluid passages are not illustrated) for adjusting the hydraulic pressures of the wheel cylinders 61-64 (hereinafter also referred to as the wheel pressures). Though not illustrated, the hydraulic pressure adjusting device 70 includes a reservoir tank, a pressure regulator including an electric motor, and a plurality of electromagnetic valves. The hydraulic pressure adjusting device 70 includes, for instance, an ESC actuator and/or an electric cylinder. The hydraulic pressure adjusting device 70 is controlled by a brake ECU 70a.

The pressure sensor 24 may be provided for each of the wheel cylinders 61-64. Alternatively, one pressure sensor 24 may be provided for the wheel cylinders 61, 62 of the front-wheel system, and one pressure sensor 24 may be provided for the wheel cylinders 63, 64 of the rear-wheel system. Further, one pressure sensor 24 may be provided for one of the front-wheel system and the rear-wheel system. In a case where the pressure sensor 24 is not provided for each of the wheel cylinders 61-64, the brake ECU 70a calculates each wheel pressure based on the detection result of one pressure sensor 24 and control details of electromagnetic valves, etc. The wheel pressure corresponds to deceleration generated by braking of the vehicle. The brake ECU 70a calculates the deceleration of the vehicle generated by the hydraulic braking based on each wheel pressure.

The controller 10 receives, as information on the deceleration of the vehicle, the detection result of the pressure sensor 24, the wheel pressures calculated by the brake ECU 70a, and/or the deceleration calculated by the brake ECU 70a.

The steering device 51 is provided with a steering angle sensor 25 configured to steer the steerable wheels 91, 92 of the vehicle. The steering angle sensor 25 is configured to detect the steering angle of the steerable wheels 91, 92. The steerable wheels 91, 92 in the present embodiment are a pair of front wheels. The steering system 1 in the present embodiment is a steer-by-wire steering system. Thus, the steering device 51 and the operation device 52 are mechanically independent of each other. The controller 10, which functions as a steering ECU, is communicably connected to the steering device 51 and the operation device 52. The steering system 1 may include, apart from the controller 10, a steering ECU configured to control the steering device 51 and the operation device 52.

The operation device 52 includes: a steering wheel 521, which is an operation member for a driver's steering operation; a steering shaft 522 to one end of which is attached the steering wheel 521: a steering column 523 rotatably holding the steering shaft 522 and supported by an instrument panel reinforcement; a reaction force application mechanism 524; and an operation angle sensor 525.

The reaction force application mechanism 524 is configured to apply, to the steering wheel 521 via the steering shaft 522, a reaction force against the steering operation by utilizing, as a force generation source, a reaction force motor 526 supported by the steering column 523. The reaction force motor 526 is an electric motor. The reaction force application mechanism 524 has an ordinary configuration including a speed reducer, etc. The reaction force motor 526 is provided with a rotational angle sensor 526a. The operation angle sensor 525 is configured to detect an operation angle of the steering wheel 521 as a steering operation amount.

In the operation device 52, a torsion bar 527 is incorporated in the steering shaft 522, as in typical power steering systems. The operation device 52 includes an operation torque sensor 528 for detecting an operation torque based on a torsional amount of the torsion bar 527. The operation torque corresponds to an operation force applied to the steering wheel 521 by the driver.

The wheels 91-94 are supported by the vehicle body via respective steering knuckles 539 such that the wheels 91-94 are turnable or steerable. The steering knuckles 539 are constituent elements of respective suspension devices. The steering device 51 rotates the steering knuckles 539 to thereby steer the pair of front wheels 91, 92 together. The steering device 51 includes a steering actuator 510 as a main constituent element.

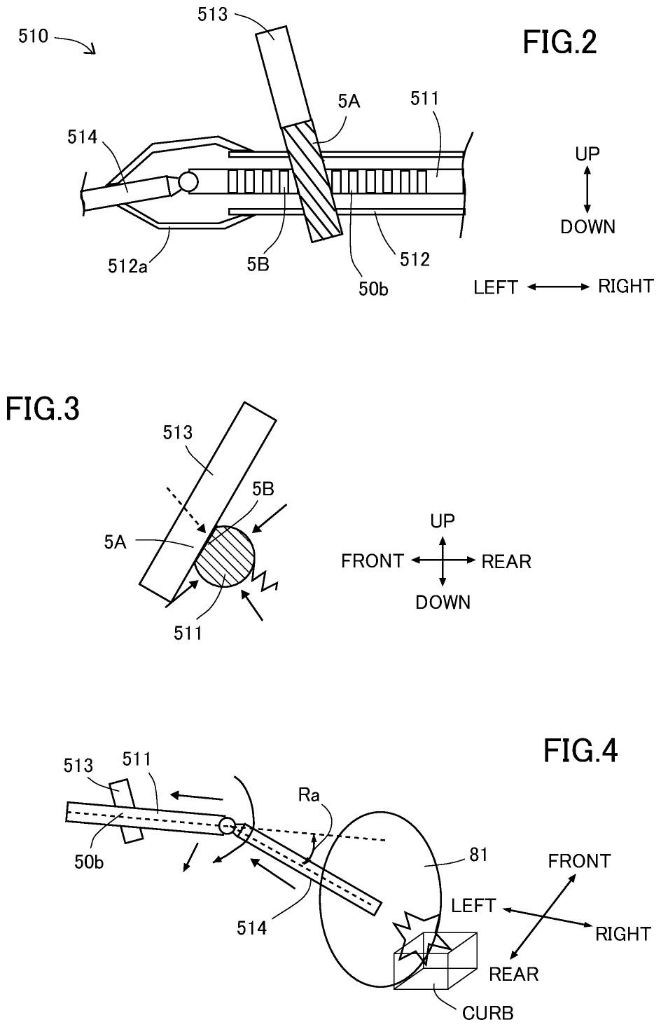

As illustrated in FIGS. 1 and 2, the steering actuator 510 includes a rack bar 511 as one example of a steering rod, a housing 512, a pinion shaft 513, tie rods 514, a steering motor 515, and a conversion mechanism 516. The rack bar 511 is coupled at opposite ends thereof to the right and left steering knuckles 539 via the corresponding tie rods 514. In other words, the left end of the rack bar 511 is connected to the steering knuckle 539 of the front left wheel 91 via the left tie rod 514 while the right end of the rack bar 511 is connected to the steering knuckle 539 of the front right wheel 92 via the right tie rod 514.

The housing 512 supports the rack bar 511 such that the rack bar 511 is movable in the right-left direction. The housing 512 is fixedly held by the vehicle body. A boot 512a is provided at each end of the housing 512 so as to cover the connecting portion of the rack bar 511 and the tie rod 514.

The pinion shaft 513 is disposed so as to intersect the rack bar 511 and includes a pinion gear 5A meshing with a rack gear 5B of the rack bar 511. The pinion shaft 513 and the rack bar 511 constitute a rack and pinion mechanism. The pinion shaft 513 is configured to rotate in accordance with the axial movement of the rack bar 511, namely, the movement of the rack bar 511 in the right-left direction. The pinion shaft 513 is provided with a rotational angle sensor as the steering angle sensor 25. The rotational angle sensor detects a rotational angle of the pinion shaft 513. The rotational angle of the pinion shaft 513 corresponds to the amount of the movement of the rack bar 511 in the right-left direction, and the amount of the movement of the rack bar 511 in the right-left direction corresponds to the steering angle of the steerable wheels 91, 92. That is, the steering angle of the steerable wheels 91, 92 can be calculated based on the rotational angle sensor that detects the rotational angle of the pinion shaft 513. In this respect, the steering angle sensor 25 may be a sensor configured to directly detect the amount of the movement the rack bar 511.

The rack and pinion mechanism including the rack bar 511 and the pinion shaft 513 in the present embodiment is constituted utilizing an existing system such as a steering system of a power steering type in which the pinion shaft 513 and the steering shaft 522 are mechanically coupled to each other. The configuration of the present embodiment is constituted as a steer-by-wire steering system in which the operation device 52 and the pinion shaft 513, which are coupled in the existing configuration, are decoupled. That is, the steering system 1 of the present embodiment is a steering system of a steer-by-wire type that utilizes, as the steering angle sensor 25, the existing rack and pinion mechanism. The thus configured rack and pinion mechanism may include a pinion assist motor as the steering motor.

The steering motor 515 is an electric motor and applies a drive force to the rack bar 511 via the conversion mechanism 516. The conversion mechanism 516 is configured to convert a rotary motion of the steering motor 515 to a linear motion of the rack bar 511. The conversion mechanism 516 includes, for instance, a large pulley 5a, a small pulley 5b, a belt 5c, and a transmission gear 5d. The belt 5c is looped over the large pulley 5a and the small pulley 5b. The transmission gear 5d is coupled to the large pulley 5a. The small pulley 5b is coupled to the output shaft of the steering motor 515 and is rotated by the drive force of the steering motor 515. The rotation of the small pulley 5b is transmitted to the large pulley 5a via the belt 5c. This causes the transmission gear 5d coupled to the large pulley 5a to be rotated. The transmission gear 5d is in mesh with a gear 51C formed on the rack bar 511. The conversion mechanism 516 is configured such that the rack bar 511 is moved in the right-left direction by the rotation of the transmission gear 5d.

The controller 10 sets a target steering angle based on the operation amount of the steering wheel 521 or the command value in automated driving. The controller 10 controls the steering motor 515 based on the target steering angle and an actual steering angle (i.e., the detection result of the steering angle sensor 25) such that a difference between the target steering angle and the actual steering angle becomes small.

The pinion shaft 513 is disposed at a position shifted from the center in the vehicle width direction to one end side in the vehicle width direction. The steering motor 515 and the conversion mechanism 516 are disposed at a position shifted from the center in the vehicle width direction to the other end side in the vehicle width direction. In the present embodiment, the pinion shaft 513 is disposed on the right side of the central position of the housing 512 in the right-left direction, and the steering motor 515 and the conversion mechanism 516 are disposed on the left side of the central position of the housing 512 in the right-left direction. That is, the rack gear 5B is located on the right side with respect to the central position of the rack bar 511 in the right-left direction while the gear 51C is located on the left side with respect to the central position of the rack bar 511 in the right-left direction. In this respect, the pinion shaft 513 and the rack gear 5B may be disposed relatively on the left side while the steering motor 515 and the conversion mechanism 516 may be disposed relatively on the right side.

When a load is applied to the front right wheel 92 in the present embodiment, the support point of the rack bar 511 against a force in the bending direction is the pinion shaft 513 of the rack and pinion mechanism located relatively on the right side. That is, when the load is applied to the front right wheel 92, a portion of the rack bar 511 corresponding to the pinion shaft 513 receives the load in the bending direction. When the load is applied to the front left wheel 91, the support point of the rack bar 511 against the force in the bending direction is the conversion mechanism 516 located relatively on the left side. That is, when the load is applied to the front left wheel 91, a portion of the rack bar 511 corresponding to the conversion mechanism 516 receives the load in the bending direction.

The rack gear 5B is formed not at a portion of the rack bar 511 where the cross section cut along the plane orthogonal to the axis of the rack bar 511 is circular but at a portion of the rack bar 511 where the circular cross section is partly cut, as illustrated in FIG. 3. The section modulus differs in the circumferential direction at a portion 50b of the rack bar 511 where the rack gear 5B is formed. The section modulus is a strength against the load in the bending direction. The section modulus against the load in a direction toward the rack gear 5B (as indicated by the dashed line in FIG. 3, for instance) is smaller at the portion 50b than at the other portion of the rack bar 511. That is, the rack bar 511 is relatively likely to deform against the load in this direction. The gear 51C is formed over the entire circumference of the rack bar 511, and the section modulus does not substantially differ in the circumferential direction of the rack bar 511 at the portion of the rack bar 511 where the gear 51C is formed.

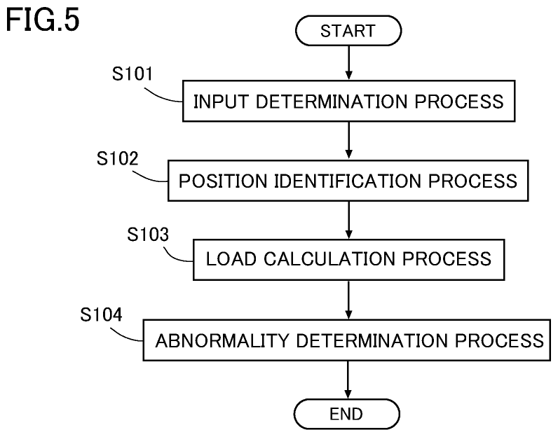

As illustrated in FIG. 4, the axial direction of the tie rod 514 is inclined with respect to the axial direction of the rack bar 511 in most cases. In the present disclosure, the angle of the inclination of the tie rod 514 will be referred to as a tie rod inclination angle Ra. The tie rod inclination angle Ra changes in accordance with a change in the vehicle height. When an external force is input to the tire, the force is transmitted to the rack bar 511 via the tie rod 514. As for the force that the rack bar 511 receives, it is considered that the force transmitted to the rack bar 511 is dissolved into a force in the axial direction of the rack bar 511 and a force in the bending direction of the rack bar 511 (See arrows in FIG. 4).

In a case where the front right wheel 92 mounts a curb or the like when the vehicle is traveling forward, for instance, there is applied, to the rack bar 511 via the tie rod 514, a force directing rearward and upward at the moment when the front right wheel 92 mounts a curb or the like. This force acts so as to cause the right end portion of the rack bar 511 to be bent rearward. The force input to the front right wheel 92 gives a relatively large influence on the rack and pinion mechanism located relatively on the right side. The bending direction of the rack bar 511 is any one of directions orthogonal to the axis of the rack bar 511. Among the bending directions, the direction of the load (the force) that the rack bar 511 receives is influenced by the tie rod inclination angle Ra. That is, the magnitude of the tie rod inclination angle Ra influences the direction of the load applied to the rack bar 511, namely, the direction of the load that the rack bar 511 receives. Hereinafter, the direction of the load will be referred to as the load direction where appropriate.

As indicated by the dashed line in FIG. 3, in a case where the load is applied to the rack gear 5B having a relatively small section modulus in the rack bar 511, it is considered that the abnormality is likely to occur in the rack bar 511 such as poor meshing of the gears and deformation and breakage of the rack bar 511. It is considered that the abnormality is likely to relatively occur when the force is applied to the rack bar 511 in a direction indicated by the arrow from the upper left to the lower right in FIG. 3.

By obtaining a relationship between the tie rod inclination angle Ra and the vehicle height and a relationship between the tie rod inclination angle Ra and the direction of the load, the controller 10 can determine whether the load is applied toward the rack gear 5B based on the vehicle height information when the tire receives the external force. The relationship between the tie rod inclination angle Ra and the vehicle height and the relationship between the tie rod inclination angle Ra and the direction of the load are preset in the controller 10. The controller can identify the direction of the load applied to the rack bar 511 based on the detection results of the vehicle height sensors 23.

As described above, the steering system 1 according to the present embodiment includes the rack bar 511, the steering motor 515 configured to apply the drive force to the rack bar 511, and the conversion mechanism 516 configured to convert the rotation of the steering motor 515 to the axial movement of the rack bar 511. The steering system 1 further includes the steering actuator 510 configured to steer the steerable wheels 91, 92, the steering angle sensor 25 configured to detect the steering angle of the steerable wheels 91, 92, the acceleration sensor 21 configured to detect longitudinal acceleration that is acceleration of the vehicle in the front-rear direction, the air pressure sensors 22 each configured to detect the air pressure of a corresponding one of the tires 81-84, and the controller 10 including at least one processor 10a and configured to obtain the information on the steering angle, the information on the longitudinal acceleration, and the information on the air pressures. The steering system 1 according to the present embodiment is a steer-by-wire system in which the steering actuator 510 is not mechanically coupled to the steering wheel 521, which functions as the operation member.

Abnormality Detection Control

There will be described an abnormality detection control executed by the controller 10. As illustrated in FIG. 5, the controller 10 is configured to execute, as the abnormality detection control, an input determination process S101, a position identification process S102, a load calculation process S103, and an abnormality determination process S104, based on the information obtained from various sensors.

In the input determination process S101, the presence or absence of an input of the external force to the vehicle is determined based on the longitudinal acceleration. In the position identification process S102, when the external force is input, an input tire is identified based on the air pressures of the tires 81-84. The input tire is one of the plurality of tires 81-84 to which the external force is input. In the load calculation process S103, when the input tire is the tire of one of the steerable wheels 91, 92, the deceleration of the vehicle is calculated or the information on the deceleration is obtained, and the load received by the input tire due to the external force is calculated based on a difference between the longitudinal acceleration and the deceleration. In the abnormality determination process S104, the presence or absence of the abnormality of the rack bar 511 is determined based on the load, the steering angle, and the detection results of the vehicle height sensors 23. In the present embodiment, the detection results of the vehicle height sensors 23 are utilized when the load direction needs to be identified. In a case where such identification is not necessary, the detection results of the vehicle height sensors 23 are not utilized.

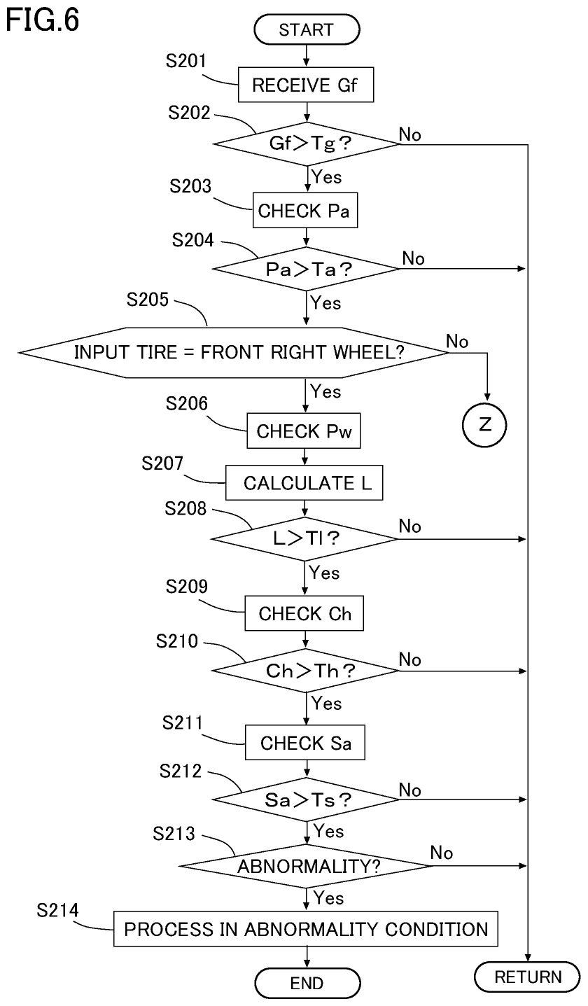

Referring to FIG. 6, the abnormality detection control for detecting the abnormality due to the load on the rack gear 5B will be explained. The controller 10 receives information on the longitudinal acceleration Gf from the acceleration sensor 21 (S201). The controller 10 determines whether the longitudinal acceleration Gf is greater than an acceleration threshold Tg (S202). When the longitudinal acceleration Gf is not greater than the acceleration threshold Tg (S202: No), the controller 10 determines that there is no input of the abnormal external force and causes the abnormality detection control to return to the initial step (S201). When the longitudinal acceleration Gf is greater than the acceleration threshold Tg (S202: Yes), the controller 10 determines that there is an input of the abnormal external force and checks the information on the air pressure of each tire 81-84 (S203).

In a time period from the input of the external force to a lapse of a predetermined time (hereinafter referred to as “determination target period” where appropriate), the controller determines whether a change rate Pa of the air pressure of any one of the tires 81-84 is greater than an air pressure threshold Ta (S204). The change rate Pa is an amount of change in the air pressure per unit time. In place of the change rate Pa, the amount of change in the air pressure may be compared with the threshold. When the change rate Pa of the air pressure of each of all the tires 81-84 is not greater than the air pressure threshold Ta (S204: No), the controller 10 determines that the abnormal external force is not applied to the tires 81-84 and causes the abnormality detection control to return to the initial step.

When the change rate Pa of the air pressure of any one of the tires 81-84 is greater than the air pressure threshold Ta (S204: Yes), the controller 10 determines whether the wheel, whose tire is the input tire to which the abnormal external force is input, is a predetermined steerable wheel 92, namely, the front right wheel 92 in the present embodiment (S205). The detection results of the respective air pressure sensors 22 are associated with the positions of the corresponding tires 81-84 by ID information, for instance. Thus, the controller 10 can recognize to which tire's air pressure information the detection result of each air pressure sensor 22 corresponds. In a case where the tire mounts a curb or the like, the tire is compressed, so that the volume of the tire is reduced and the air pressure is increased. In a case where the air pressure of the input tire is rapidly increasing, for instance, it is likely that the abnormal external force has been applied.

When the wheel corresponding to the input tire is not the front right wheel 92 (S205: No), the controller 10 determines that there is no influence on the rack gear 5B, and the control flow then proceeds to a process Z. The process Z will be later explained in detail. When the wheel corresponding to the input tire is the front right wheel 92 (S205: Yes), the controller 10 checks the information on each wheel pressure Pw at a time when the external force is input, for examining an influence on the rack gear 5B (S206). The controller 10 calculates a load L applied to the input tire due to the external force based on the wheel pressures Pw and the longitudinal acceleration Gf (S207). It can be said that the controller 10 estimates, by calculation, an estimated load, which is a load estimated to be received by the input tire. The load L may be referred to as an input load at the position of the input tire.

The load L is calculated based on a difference between the longitudinal acceleration Gf and the deceleration Gd. The deceleration Gd is calculated based on each wheel pressure Pw. For instance, the deceleration for one wheel is calculated based on the wheel pressure Pw, a wheel cylinder diameter of a caliper, a friction coefficient of brake pads, a braking effective radius/tire dynamic load radius, and an estimated road surface friction coefficient. The arithmetic expression is represented as follows, for instance: the deceleration for one wheel=the wheel pressure×the wheel cylinder diameter of the caliper×the friction coefficient of the brake pads×(the braking effective radius/the tire dynamic load radius)×the estimated road surface friction coefficient.

The deceleration is calculated for each wheel 91-94, so that the deceleration Gd of the vehicle as a whole is calculated. The controller 10 may obtain the information on the deceleration Gd from the brake ECU 70a. In other words, the controller 10 may receive the information on the deceleration Gd calculated by the brake ECU 70a.

The load L is calculated based on the longitudinal acceleration Gf, the deceleration Gd, and the estimated vehicle weight W. For instance, the load L is calculated by multiplying the difference between the longitudinal acceleration Gf and the deceleration Gd by the estimated vehicle weight W. The arithmetic expression is represented as follows: L=(Gf−Gd)×W. The estimated vehicle weight W is a weight of the vehicle and is set based on an initial set value, e.g., the weight of the vehicle only, stored in the controller 10. For instance, the controller 10 sets, to the estimated vehicle weight W, a value obtained by adding an occupant weight and/or a baggage weight to the initial set value. The controller 10 may set the initial set value itself to the estimated vehicle weight W.

The controller 10 grasps the number and/or the weight of occupants based on detection results of seat sensors 27 provided for the respective seats. The controller 10 adds the occupant weight to the initial set value in accordance with the detection result of each seat sensor 27. This configuration enables the load L to be calculated based on the weight closer to the current situation, thus enhancing the calculation accuracy of the load L and accordingly enhancing the detection accuracy of the abnormality. The controller 10 may add, to the estimated vehicle weight W, the baggage weight obtained by a function of a baggage weight detector or obtained by user's setting, for instance. The seat sensor 27 is, for instance, a load sensor for detecting a change in load or a capacitve sensor for detecting a change in capacitance.

The controller 10 determines whether the calculated load L is greater than a load threshold Tl (S208). When the load L is not greater than the load threshold Tl (S208: No), the controller 10 determines that the input tire does not receive the load that causes the abnormality. In this instance, the controller 10 causes the abnormality detection control to return to the initial step. When the load L is greater than the load threshold Tl (S208: Yes), the controller 10 checks the vehicle height information in the determination target period (S209).

The controller 10 determines whether the vehicle height stroke Ch has exceeded a vehicle height threshold Th within the determination target period (S210). The vehicle height stroke Ch corresponds to the load direction. Further, based on findings obtained by simulations, tests, and the like, it can be determined in the present embodiment that the load direction is not a direction toward the rack gear 5B if the vehicle height stroke Ch is small. The relationship between: the vehicle height stroke Ch or the vehicle height Hv; and the direction of load to the rack bar 511 differs depending on vehicle configurations.

When the vehicle height stroke Ch is not greater than the vehicle height threshold Th within the determination target period (S210: No), the controller 10 determines that the load direction is not the direction corresponding to the rack gear 5B. In this case, the controller causes the abnormality detection control to return to the initial step. At Step S210, the controller 10 may compare a maximum value of the vehicle height stroke Ch in the determination target period with the vehicle height threshold Th. The controller 10 can calculate the vehicle height Hv at any given time point based on the initial vehicle height and the vehicle height stroke Ch. That is, the vehicle height stroke Ch is convertible to the vehicle height Hv.

When the vehicle height stroke Ch exceeds the vehicle height threshold Th within the determination target period (S210: Yes), the controller 10 checks the steering angle Sa of the steerable wheels 91, 92 within the determination target period (S211). The steering angle Sa corresponds to a projection allowance of the rack bar 511. The greater the steering angle Sa, the greater the projection allowance of the rack bar 511 toward one of opposite sides thereof in the axial direction. The projection allowance of the rack bar 511 is an amount of the movement of the rack bar 511 from the neutral position toward the one side in the axial direction. The projection allowance of the rack bar 511 is as follows. When the rack bar 511 moves leftward, the projection allowance of the rack bar 511 is an amount by which the left end of the rack bar 511 moves leftward from the neutral position. When the rack bar 511 moves rightward, the projection allowance of the rack bar 511 is an amount by which the right end of the rack bar 511 moves rightward from the neutral position. The neutral position of the rack bar 511 is a position at which the rack bar 511 is located when the vehicle travels straight.

When the vehicle is turning, the rack bar 511 protrudes on one of its right-hand side and left-hand side while the rack bar 511 does not protrude on the other of the right-hand side and left-hand side. In a case where the input tire is the tire located on the projected one of the right-hand side and left-hand side of the rack bar 511, the greater the projection allowance of the rack bar 511, the greater the moment length. This causes an increase in the load in the bending direction applied to the rack bar 511. Thus, the controller 10 determines whether the steering angle Sa within the determination target period is greater than a steering angle threshold Ts (S212). The steering angle Sa may vary in a period during which the external force is being input. The steering angle Sa that thus changes is also the target for the determination because the controller 10 checks the steering angle Sa within the determination target period.

When the steering angle Sa is not greater than the steering angle threshold Ts within the determination target period (S212: No), the controller 10 determines that the influence of the external force on the rack bar 511 is small and causes the abnormality detection control to return to the initial step. When the steering angle Sa exceeds the steering angle threshold Ts within the determination target period (S212: Yes), the controller 10 determines the presence or absence of the abnormality of the rack bar 511 based on the preset abnormality determination map M1, the steering angle Sa, and the vehicle height information (S213). The vehicle height information is the vehicle height stroke Ch of the wheel corresponding to the input tire, i.e., the front right wheel 92, or the vehicle height Hv that is based on the vehicle height stroke Ch.

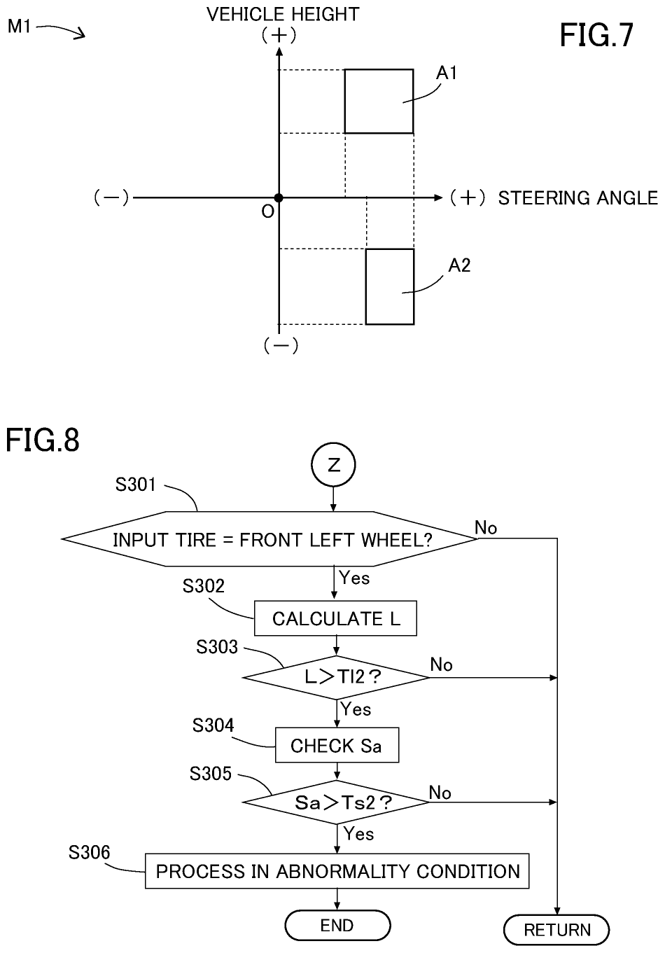

In the abnormality determination map M1 of the present embodiment illustrated in FIG. 7, the horizontal axis represents the steering angle, and the vertical axis represents the vehicle height. The more the value of the steering angle goes to the right side (+) from an origin O along the horizontal axis, the greater the projection allowance of the rack bar 511 to the right. The more the value of the steering angle goes to the left side (−) from the origin O along the horizontal axis, the greater the projection allowance of the rack bar 511 to the left. The controller 10 can grasp the direction of projection of the rack bar 511 based on the detection result of the steering angle sensor 25. The abnormality determination map M1 is set for determining the presence or absence of the abnormality of the rack gear 5B. Thus, a case where the rack bar 511 protrudes rightward from the neutral position is a target case for the determination of the abnormality.

The more the value of the vehicle height Hv goes to the lower side (−) from the origin O along the vertical axis, the greater the amount by which the vehicle sinks, namely, the greater the amount of bounding. The more the value of the vehicle height Hv goes to the upper side (+) from the origin O along the vertical axis, the more the amount by which the vehicle lifts up, namely, the greater the amount of rebounding. When the tire mounts a curb or the like, for example, the input tire moves upward and downward. In this instance, the vehicle height detected at the wheel corresponding to the input tire changes upward and downward. The determination target period is set to a period equal to or longer than a variation period in which the upward and downward change of the vehicle height caused by the external force is expected. It is assumed in the present embodiment that one collision or mounting causes the external force to be input continuously for a predetermined time.

In the abnormality determination map M1, an area where the abnormality is determined by the controller 10 is set in each of the first quadrant and the fourth quadrant. A first area A1 is set in the first quadrant, and a second area A2 is set in the fourth quadrant. Here, the horizontal axis is X, and the vertical axis is Y. The area A1 is set so as to satisfy the following expression: a projection-allowance lower limit value≤X≤a projection-allowance upper limit value. The area A2 is set so as to satisfy the following expression: a vehicle-height lower limit value ≤Y≤a vehicle-height upper limit value. The projection-allowance upper limit value and the vehicle-height upper limit value need not be necessarily set. The range of the steering angle corresponding to each area A1, A2 is a first predetermined range, and the range of the vehicle height Hv or the vehicle height stroke Ch corresponding to each area A1, A2 is a second predetermined range. That is, the controller 10 determines in the load calculation process S103 that the rack bar 511 suffers from the abnormality when the load L is greater than the load threshold and the value of the steering angle Sa falls within the first predetermined range and the value of the vehicle height stroke Ch or the vehicle height Hv falls within the second predetermined range in the determination target period. The XY coordinate used for the determination may be either (Sa, Hv) or (Sa, Ch).

The controller 10 determines whether the coordinate (Sa, Hv) falls within the first area A1 or the second area A2 in the determination target period (S213). When the coordinate (Sa, Hv) falls within the first area A1 or the second area A2 (S213: Yes), the controller 10 determines that there is the abnormality in the rack bar 511. In this instance, the controller 10 sets an abnormality flag and executes a process in the abnormality condition (S214).

The process in the abnormality condition is for notifying the driver of the abnormality of the rack bar 511 by illumination of a warning lamp, indication of a warning on a display, or warning by voice, for instance. On the other hand, when the coordinate (Sa, Hv) does not fall within the first area A1 or the second area A2 (S213: No), the controller 10 determines that there is no abnormality in the rack bar 511. The controller 10 then causes the abnormality detection control to return to the initial step.

The order of comparisons between various sets of the information and the corresponding thresholds may be suitably modified. For instance, Step S210 and Step S212 may be reversed in order. The controller 10 may omit the comparison between the steering angle Sa and the steering angle threshold Ts and the comparison between the vehicle height stroke Ch and the vehicle height threshold Th. The controller 10 may perform a comparison between the coordinate (Sa, Hv) and the abnormality determination map M1. That is, Steps S210 and S212 in the abnormality detection control may be omitted. The vertical axis in the abnormality determination map M1 may be the vehicle height stroke Ch instead of the vehicle height Hv.

Process Z

When it is determined in the abnormality detection control that the input tire is not the front right wheel 92 (S205: No), the controller 10 executes the process Z. In the process Z illustrated in FIG. 8, the controller 10 determines whether the input tire is the front left wheel 91 (S301). When the input tire is not the front left wheel 91 (S301: No), the controller 10 determines that there is no influence of the external force on the rack bar 511 and causes the abnormality detection control to return to the initial step (S201).

When the input tire is the front left wheel 91 (S301: Yes), the controller 10 calculates the load L based on the longitudinal acceleration Gf, the deceleration Gd, and the estimated vehicle weight W, as at Steps S206 and S207 (S302). The controller 10 determines whether the load L is greater than a load threshold T12 (S303). When the load L is not greater than the load threshold T12 (S303: No), the controller 10 determines that the input tire does not receive the load that causes the abnormality. In this instance, the controller 10 causes the abnormality detection control to return to the initial step.

When the load Lis greater than the load threshold T12 (S303: Yes), the controller 10 checks the steering angle Sa within the determination target period (S304). The controller 10 determines whether the steering angle Sa within the determination target period is greater than a steering angle threshold Ts2 (S305). When the steering angle Sa is not greater than the steering angle threshold Ts2 (S305: No), the controller 10 determines that the influence of the external force on the portion of the rack bar 511 where the conversion mechanism 516 is provided is small. In this instance, the controller 10 causes the abnormality detection control to return to the initial step. The input of the external force to the front left wheel 91 influences the portion of the rack bar 511 corresponding to the conversion mechanism 516, which is the support point on the relatively left-hand side of the rack bar 511. As described above, the input of the external force to the front right wheel 92 influences the portion 50b corresponding to the pinion shaft 513, which is the support point on the relatively right-hand side of the rack bar 511.

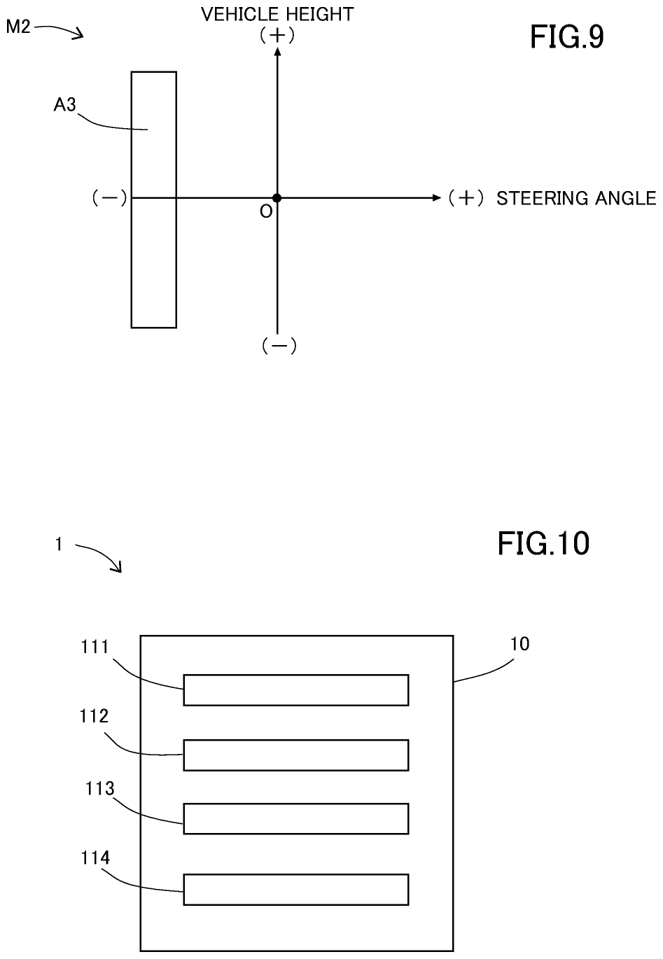

When the steering angle Sa is greater than the steering angle threshold Ts2 (S305: Yes), the controller 10 determines that the load in the bending direction applied to the portion corresponding to the support point of the rack bar 511, i.e., the conversion mechanism 516, is great. Thus, the controller determines that the rack bar 511 suffers from the abnormality. The controller 10 then sets the abnormality flag and executes the process in the abnormality condition (S306), as at Step S214. The controller 10 may store, for instance, an abnormality determination map M2 illustrated in FIG. 9 in which a third area A3 is set as the abnormality determination area. The portion of the rack bar 511 corresponding to the conversion mechanism 516 has substantially the same section modulus over the entire circumference of the rack bar 511, unlike the rack gear 5B. Thus, the controller 10 can determine the presence or absence of the abnormality based on the magnitude of the load L and the magnitude of the steering angle Sa without depending on the vehicle height stroke Ch or the vehicle height Hv.

### Advantageous Effects

According to the present embodiment, when the vehicle mounts a curb or the like and the external force is input to any one of the tires 81-84, the input tire is identified and the load applied to the input tire is calculated. The load in the bending direction applied to the rack bar 511 is influenced by the load L in the front-rear direction and the steering angle Sa. The greater the load L in the front-rear direction, the greater the load in the bending direction applied to the rack bar 511. The greater the projection allowance of the rack bar 511 with respect to the input tire, the greater the moment length, resulting in an increase in the load in the bending direction applied to the rack bar 511. The projection allowance of the rack bar 511 corresponds to the steering angle Sa. The controller 10 determines the presence or absence of the abnormality of the rack bar 511 based on the load L and the steering angle Sa. The configuration according to the present embodiment enables detection of the abnormality of the rack bar 511 due to the load in the bending direction. In particular, the steering system 1 of the present embodiment is the steer-by-wire steering system, and it is difficult for the driver to detect the abnormality of the rack bar 511. The configuration according to the present embodiment enables detection of the abnormality of the rack bar 511.

In the present embodiment, the controller 10 determines the presence or absence of the abnormality of the rack bar 511 also based on the vehicle height information. The present embodiment employs, as the steering rod, the rack bar 511 that includes the rack gear 5B engaging with the pinion gear 5A. The controller 10 is configured to obtain the information on the height of the vehicle. The controller 10 is configured to determine, in the abnormality determination process S104, the presence or absence of the abnormality of the rack bar 511 based on the load L, the steering angle Sa, and the vehicle height stroke Ch.

The influence that the rack bar 511 receives due to the load in the bending direction changes depending on the tie rod inclination angle Ra and the projection allowance of the rack bar 511. The magnitude of the tie rod inclination angle Ra influences the direction of the load applied to the rack bar 511. The projection allowance of the rack bar 511 influences the magnitude of the load applied to the rack bar 511 since the projection allowance corresponds to the moment length. Further, since the rack gear 5B is formed on the rack bar 511, the strength with respect to the load in the bending direction, namely, the section modulus, differs in the circumferential direction of the rack bar 511.

The vehicle height stroke Ch corresponds to the tie rod inclination angle Ra, and the tie rod inclination angle Ra corresponds to the direction of the load. Further, the steering angle Sa corresponds to the projection allowance of the rack bar 511. Thus, the direction and the magnitude of the load applied to the rack bar 511 can be calculated based on the vehicle height stroke Ch (or the vehicle height Hv) and the steering angle Sa at the time of application of the external force. Thus, the steering system according to the present embodiment enables accurate detection of the abnormality of the rack bar 511 due to the load in the bending direction applied to the rack bar 511 while taking account of the section modulus of the rack gear 5B. In the present embodiment, the direction of the load is estimated, and it is determined whether the load is applied toward the rack gear 5B, thus enabling more accurate detection of the presence or absence of the abnormality of the rack bar 511.

In the load calculation process S103, the estimated vehicle weight W is set in consideration of the occupant weight utilizing the detection results of the seat sensors 27. The steering system 1 includes the seat sensor 27 provided for each of at least one seat to detect the presence or absence of the occupant. In the load calculation process S103, the controller 10 calculates the load L based on the longitudinal acceleration Gf, the deceleration Gd, and the estimated vehicle weight W. The controller 10 sets the estimated vehicle weight W to a value obtained by adding the occupant weight based on the detection results of the seat sensors 27. This enables calculation of the load L that matches the ride condition of the vehicle.

Modifications

The present disclosure is not limited to the embodiment illustrated above. For instance, the present disclosure is applicable to not only the steering system of steer-by-wire type but also the system in which the steering actuator 510 and the operation device 52 are mechanically coupled to each other, such as the steering system of power steering type. The present disclosure is applicable to the steering system 1 in which the steering wheel 521 and the pinion shaft 513 are mechanically coupled to each other. In this instance, a pinion assist motor is coupled to the pinion shaft 513, for instance. The pinion assist motor corresponds to the steering motor, and the pinion shaft 513 corresponds to the conversion mechanism.

The steering rod may be a shaft of a ball nut type, in place of the rack bar 511. In this case, the conversion mechanism is a ball nut mechanism. One or a plurality of electric motors configured to apply the drive force to the steering rod may be one or more of a rack assist motor, a pinion assist motor, and a column assist motor, for instance. The conversion mechanism needs to be configured so as to correspond to the steering motor and needs to have a configuration to transmit the drive force of the steering motor to the steering rod. The present disclosure is applicable to automated driving vehicles.

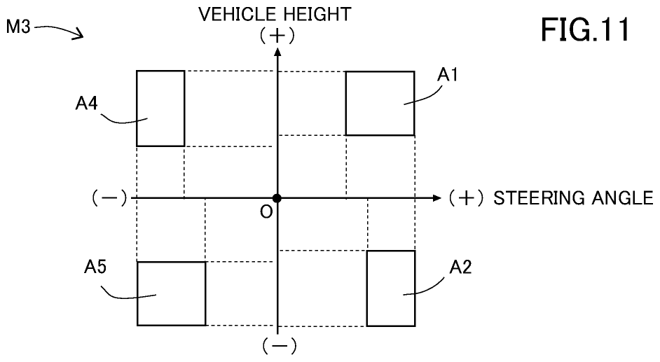

The steering actuator 510 may be of a dual pinion assist type configured to move the rack bar 511 by two rack and pinion mechanisms. That is, two pinion shafts 513, i.e., right and left pinion shafts 513, may be disposed for the rack bar 511, and each pinion shaft 513 may be provided with a pinion assist motor for rotating the pinion shaft 513. In other words, the steering actuator 510 includes two rack and pinion mechanisms (conversion mechanisms) spaced apart in the right-left direction and two the pinion assist motors (steering motors) spaced apart in the right-left direction. In this configuration, irrespective of whether the input tire is the front right wheel 92 or the front left wheel 91, the support point is one of the two pinion shafts 513 that corresponds to the input tire. Thus, the load may be possibly applied toward the rack gear 5B. In this instance, the controller 10 may determine the presence or absence of the abnormality according to an abnormality determination map M3 illustrated in FIG. 11 in which an abnormality determination area A4 is set in the second quadrant and an abnormality determination area A5 is set in the third quadrant.

In a configuration in which the input of the external force to the left steering rod influences the relatively right support point, the abnormality determination area may be set in each of the second quadrant and the third quadrant as illustrated in FIG. 11, in addition to the first quadrant and the fourth quadrant. Similarly, in a configuration in which the input of the external force to the right steering rod influences the relatively left support point, the abnormality determination area may be set in each of the first quadrant and the fourth quadrant, in addition to the second quadrant and the third quadrant.

Each of the abnormality determination maps M1, M2 may be set for each load L, e.g., for each of a plurality of ranks of the load L, each rank corresponding to a predetermined range of the load L, for instance. In this case, the range of the first load rank may be set so as to satisfy “the load threshold≤the load L≤L1”, the range of the second load rank may be set so as to satisfy “L1≤L≤L2, and the range of the third load rank may be set so as to satisfy “L2≤L”. In this configuration, the controller 10 may store an abnormality determination map that is referred to when the load L falls within the range of the first load rank, an abnormality determination map that is referred to when the load L falls within the range of the second load rank, and an abnormality determination map that is referred to when the load L falls within the range of the third load rank. According to this configuration, it is possible to determine that the steering rod suffers from the abnormality when the load L is unusually great even though the projection allowance of the steering rod (e.g., the rack bar 511) is small. That is, it is possible to determine the abnormality in accordance with the load L.

A plurality of abnormality determination maps may be set so as to correspond to the magnitude of the section modulus of the steering rod. For instance, the controller 10 may store an abnormality determination map that is referred to when the load is applied toward a portion where the section modulus is relatively small and an abnormality determination map that is referred to when the load is applied toward a portion where the section modulus is relatively large. The abnormality determination map may be set based on the direction of the load. In this case, the controller 10 identifies the direction of the load based on the vehicle height information, selects the abnormality determination map corresponding to the direction of the load, and determines the presence or absence of the abnormality. In the present disclosure, “load” can be replaced with “force”.

The steering system 1 according to the present disclosure can be rephrased as follows. As illustrated in FIG. 10, the steering system 1 includes: an input determination portion 111 configured to determine the presence or absence of the input of the external force to the vehicle based on the information on the longitudinal acceleration Gf; a position identification portion 112 configured to, when the input determination portion 111 determines the presence of the input of the external force, identify the input tire that is one of the plurality of tires 81-84 to which the external force is input, based on the air pressures of the tires; a load calculating portion 113 configured to, when the input tire is the tire of one of the steerable wheels 91, 92, (a) calculate the deceleration Gd of the vehicle or obtain the information on the deceleration Gd and (b) calculate the load L received by the input tire due to the external force based on a difference between the longitudinal acceleration Gf and the deceleration Gd; and an abnormality determination portion 114 configured to determine the presence or absence of the abnormality of the steering rod of the steering device 51 based on the load L and the steering angle Sa. The abnormality determination portion 114 determines the presence or absence of the abnormality of the rack bar 511 based on the load L, the steering angle Sa, and the vehicle height stroke Ch. The abnormality determination portion 114 determines that the rack bar 511 is abnormal when the load L is greater than the load threshold Tl and the steering angle Sa falls within the first predetermined range and the vehicle height stroke Ch or the vehicle height Hv falls within the second predetermined range in the time period from the input of the external force to a lapse of a predetermined time, i.e., the determination target period. The load calculating portion 113 calculates the load L based on the longitudinal acceleration Gf, the deceleration Gd, and the estimated vehicle weight W and sets the estimated vehicle weight W to a value obtained by adding the occupant weight based on the detection results of the seat sensors 27. It is noted that each of two or more of the plurality of tires 81-84 may be identified as the input tire.

The present disclosure can be rephrased as follows. The controller 10 according to the present disclosure includes at least one processor 10a and is configured to obtain the information on the longitudinal acceleration Gf that is the acceleration of the vehicle in the front-rear direction, the information on the air pressure of each tire of the vehicle, the information on the deceleration Gd generated by braking of the vehicle, and the information on the steering angle Sa of the steerable wheels 91, 92 of the vehicle. The controller 10 is configured to execute the input determination process S101, the position identification process S102, the load calculation process S103, and the abnormality determination process S104 described above.

What is claimed is:

1. A steering system, comprising:
a steering actuator including a steering rod, a steering motor configured to apply a drive force to the steering rod, and a conversion mechanism configured to convert rotation of the steering motor to an axial movement of the steering rod, the steering actuator being configured to steer a steerable wheel;
a steering angle sensor configured to detect a steering angle of the steerable wheel;
an acceleration sensor configured to detect longitudinal acceleration that is acceleration of a vehicle in a front-rear direction;
an air pressure sensor configured to detect an air pressure of each of a plurality of tires; and
a controller including at least one processor and configured to obtain information on the steering angle, information on the longitudinal acceleration, and information on the air pressures of the plurality of tires,
wherein the controller is configured to execute:
an input determination process in which the controller determines presence or absence of an input of an external force to the vehicle based on the longitudinal acceleration;
a position identification process in which, when the controller determines that the external force is input to the vehicle, the controller identifies an input tire that is one of the plurality of tires to which the external force is input, based on the air pressures of the plurality of tires;
a load calculation process in which, when the input tire is the tire of the steerable wheel, the controller (a) calculates deceleration of the vehicle or obtains information on the deceleration and (b) calculates a load received by the input tire due to the input of the external force based on a difference between the longitudinal acceleration and the deceleration; and
an abnormality determination process in which the controller determines presence or absence of an abnormality of the steering rod based on the load and the steering angle.

2. The steering system according to claim 1, further comprising a vehicle height sensor configured to detect a height or a height stroke of the vehicle,
wherein the steering rod is a rack bar including a rack gear engaging with a pinion gear, and
wherein the controller is configured to determine, in the abnormality determination process, presence or absence of an abnormality of the rack bar based on the load, the steering angle, and a detection result of the vehicle height sensor.

3. The steering system according to claim 2, wherein the controller determines, in the abnormality determination process, that the rack bar is abnormal when the load is greater than a load threshold and the steering angle falls within a first predetermined range and the height stroke or the height of the vehicle falls within a second predetermined range in a time period from the input of the external force up to a lapse of a predetermined time.

4. The steering system according to claim 1, further comprising a seat sensor provided for each of at least one seat to detect presence or absence of an occupant,
wherein the controller calculates, in the load calculation process, the load based on the longitudinal acceleration, the deceleration, and an estimated weight of the vehicle, and
wherein the controller sets the estimated weight of the vehicle to a value to which an occupant weight is added, based on a detection result of the seat sensor.

5. The steering system according to claim 1, which is a steer-by-wire steering system in which the steering actuator and an operation member are not mechanically coupled.
